(19) United States
(12) Patent Application Publication
(10) Pub. No.: US 2010/0320246 A1
(43) Pub. Date: Dec. 23, 2010

(54) SHOPPING BAG SYSTEM

(76) Inventor: JENNIFER TAYLOR, BURBANK, CA (US)

Correspondence Address: ITALIA IP, 3500 WEST OLIVE AVE., SUITE 300, BURBANK, CA, 91505, US

(21) Appl. No.: 12/868,962

(22) Filed: Aug. 26, 2010

Related U.S. Application Data
(63) Continuation-in-part of application No. 12/107,756, filed on Apr. 22, 2008.

(51) Int. Cl. B60R 7/00; B65D 30/00; B65D 33/06

(52) U.S. Cl. 224/411; 383/37; 383/6

(57) ABSTRACT

A shopping bag system comprising a plurality of handled bags and a primary bag. The primary bag comprises a front face, a rear face, a pair of opposing end walls and a bottom. The end walls and bottom connect the front face to the rear face thereby defining a chamber. The chamber is capable of receiving the plurality of handled bags, and, upon removing the handled bags from the chamber, the chamber is capable of retaining shopping items therein. A fastener is coupled to one of the opposing end walls, the front face, or the rear face. The fastener is capable of releasably securing the primary bag to a shopping cart. The primary bag may be securably foldable to a U-configuration.

### REFERENCE TO RELATED APPLICATION

This application is a Continuation-In-Part of Ser. No. 12/107,756, filed Apr. 22, 2008.

### BACKGROUND

This application relates generally to shopping bags. More specifically, this application relates to a shopping bag system which includes a primary bag and a plurality of handled bags.

### SUMMARY

The widespread use of shopping bags for carrying items purchased in various stores, and especially in markets where numerous items are packaged in bags for carrying the items home, more recently has come under close scrutiny from the standpoint of conservation and preservation of the ecology. Thus, use of the ubiquitous disposable paper bag has been questioned as being responsible for using up valuable resources to manufacture the bags as well as from the standpoint of overburdening the facilities for disposal of the bags. Plastic bags have been suggested as an alternative to paper bags, but even plastic bags use valuable resources and present disposal problems. Accordingly, it would be advantageous to have available a shopping bag system which is effective for marketing purposes and which does not tax resources and disposal facilities, yet is convenient and efficient so as to encourage use.

This application discloses a shopping bag system that is economical to produce, of simple construction and capable of mass production, but also capable of providing a user a suitable means to conveniently and efficiently store and transport shopping items.

In particular, this application discloses a shopping bag system comprising a plurality of handled bags and a primary bag. The primary bag comprises a front face, a rear face, a pair of opposing end walls and a bottom. The end walls and bottom connect the front face to the rear face thereby defining a chamber. The chamber is capable of receiving the plurality of handled bags, and, upon removing the handled bags from the chamber, the chamber is capable of retaining shopping items therein. A fastener is coupled to one of the opposing end walls, the front face, or the rear face. The fastener is capable of releasably securing the primary bag to a shopping cart.

This application also discloses a shopping bag system comprising a plurality of handled bags and a primary bag. The primary bag has an inner chamber capable of retaining the plurality of handled bags therein. In addition, upon removing the handled bags from the chamber, the chamber is operable to retain shopping items therein. A fastener is coupled to the primary bag and capable of releasably securing the primary bag to a shopping cart.

Finally, this application discloses a shopping bag system comprising a plurality of handled bags and a primary bag. The primary bag comprises a front face, a rear face, a pair of opposing corrugated end walls and a bottom. The end walls and bottom connect the front face to the rear face thereby defining a chamber. The chamber is capable of receiving the plurality of handled bags, and, upon removing the handled bags from the chamber, the chamber is capable of retaining shopping items therein. The primary bag is capable of a compact arrangement, where the front face is adjacent to the rear face, and an expanded arrangement, where the front face is space apart from the rear face. A fastener is coupled to one of the opposing end walls, the front face, or the rear face. The fastener is capable of releasably securing the primary bag to a shopping cart.

In a further aspect of the invention, the primary bag may be capable of being secured in a folded condition to establish the configuration of a “U”.

### BRIEF DESCRIPTION OF THE DRAWINGS

The drawings, when considered in connection with the following description, are presented for the purpose of facilitating an understanding of the subject matter sought to be protected.

FIG. 1 is an environmental view of a first embodiment of a shopping bag system showing the shopping bag system releasably secured to a shopping cart;

FIG. 2 is a perspective view of the shopping bag system of FIG. 1;

FIG. 3 is a top view of the shopping bag system of FIG. 1;

FIG. 4 is a perspective view of a handled bag;

FIG. 5 is a perspective view of a second embodiment of a shopping bag system showing the primary bag in a compact arrangement; and

FIG. 6 is a second perspective view of the shopping bag system of FIG. 4 showing the primary bag in an expanded arrangement.

FIG. 7 is a side perspective view of a shopping bag which may be utilized with a shopping bag system according to the present invention according to at least a further aspect of the invention.

FIG. 8 is a perspective view of the shopping bag of FIG. 7, rotated to reveal that side which is concealed in the view of FIG. 7.

### DETAILED DESCRIPTION

While the present shopping bag system is described with reference to several illustrative embodiments described herein, it should be clear that the present invention should not be limited to such embodiments. Therefore, the description of the embodiments provided herein is illustrative of the present invention and should not limit the scope of the invention as claimed.

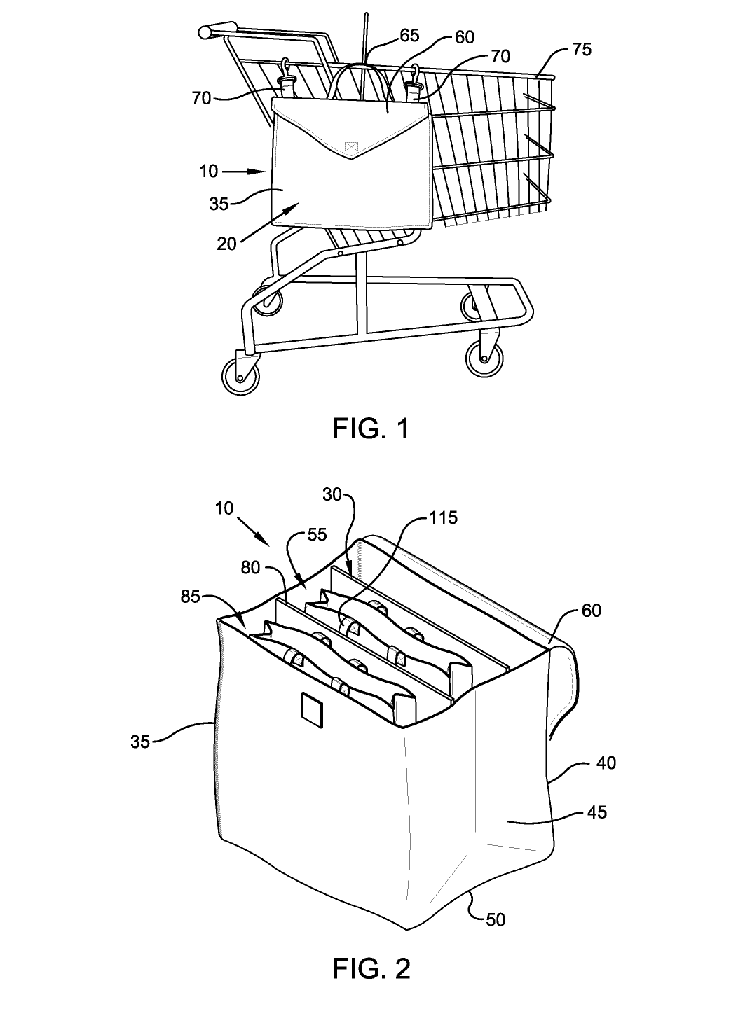

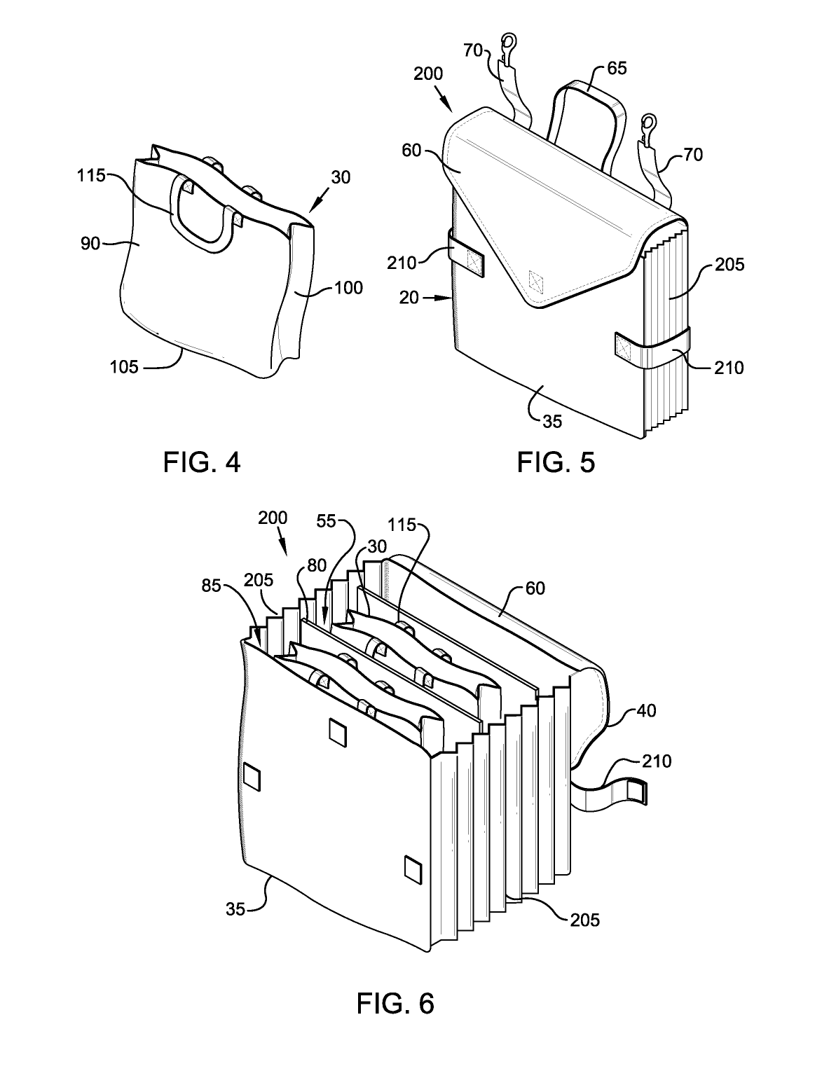

Referring now to FIGS. 1-4, a first illustrative embodiment of a shopping bag system 10 is shown. The shopping bag system 10 generally comprises a primary bag 20 and a plurality of handled bags 30. The primary bag 10 includes a front face 35, rear face 40, side walls 45 and a bottom 50. The primary bag 10 has an inner chamber 55 for receiving the plurality of handled bags 30 and/or shopping items. However, it will be appreciated that the primary bag 20 may have any suitable construction; for example, the primary bag may include front and rear panels which are secured together to form a pocket, or chamber, therebetween, etc. The primary bag 20 may be constructed from any suitable material, including but not limited to a polymer, fabric, etc. In addition, the primary bag 20 may be insulated to assist in maintaining the temperature of shopping items being transported therewith.

The primary bag 20 may include a top cover 60 which is hinged to the upper edge of the rear face 40. However, it will be appreciated that the top cover 60 may be hinged at any suitable location; for example, the top cover 60 may be hingedly secured to the front face 35, one of the side walls 45, etc. The top cover 60 may be releasably secured in a closed position to the front face 35 by any suitable means, including but not limited to Velcro, magnets, buckle, hooks, etc. Alternatively, the primary bag 20 may not have any top cover 60.

In addition, the primary bag 20 may also include a shoulder strap 65. While the illustrative embodiment shows the shoulder strap 65 affixed to the rear face 40, it will be appreciated that the shoulder strap 65 may be affixed at any suitable location; for example, the shoulder strap 65 may be affixed to at least one of the front face 35, side walls 45 and/or top cover 60.

The primary bag 20 also includes one or more swivel clips 70 secured to the rear face 40. However, it will be appreciated that the swivel clips 70 may be secured to any suitable location, such as the front face 35, side walls 45 and/or top cover 60. The swivel clips 70 are operable to releaseably secure the primary bag 20 to a shopping cart 75. Thus, a user may releasably secure the primary bag 20 to a shopping cart 75 while the user shops. While the illustrative embodiment shows swivel clips 70 for securing the primary bag 20 to a shopping cart 75, it will be appreciated that any fastener suitable for releasably securing the primary bag 20 to a shopping cart 75 may be employed and are contemplated herein. Such fasteners may include, but are not limited to, magnets, Velcro straps, hooks, buckles, etc.

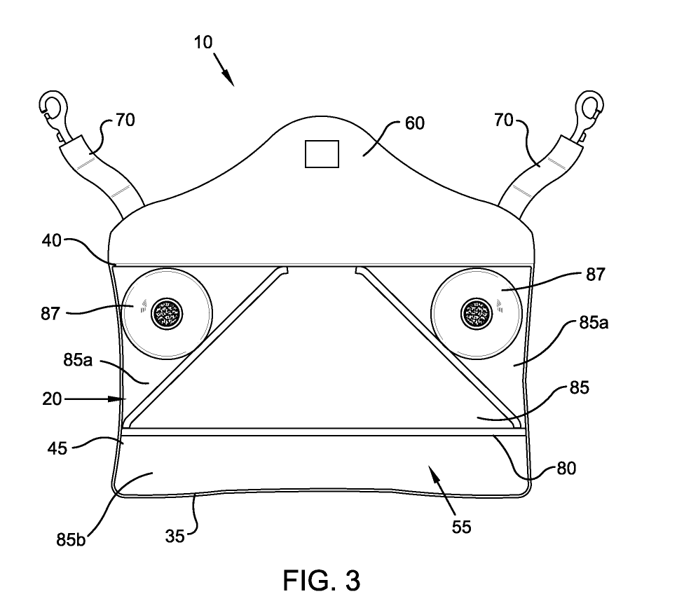

The primary bag 20 may also include one or more partitions 80 for subdividing the inner chamber 55 into smaller chambers 85 so as to assist in keeping the handled bags 30 organized and/or the shopping items organized or separated. The partitions 80 may be permanently affixed within the inner chamber 55 or may be releasably secured within the inner chamber 55 by any suitable means, including but not limited to Velcro, magnets, hooks, buckles, etc. For example, the front face 35, rear face 40, side walls 45 and/or top cover 60 may include loops operable to receive corresponding hooks on the one or more partitions 80 such that the user may subdivide the inner chamber 55 into any suitable number and/or any suitably shaped smaller chambers 85, 85a, 85b. As best shown in FIG. 3, a partition may be disposed from one side wall 45 to the rear face 40 so as to define a triangularly shaped smaller chamber 85a capable of receiving a bottle 87 therein. In addition, a partition 80 may be disposed between the side walls 45 to create a rectangularly shaped smaller chamber 85b. The number of inner chambers 85, 85a, 85b, and shapes thereof may be selected by the user to best fit his or her needs. Thus, the forgoing shapes and numbers of chambers 85, 85a, 85b are by way of example only and the various ways to arrange the partitions 80 to create the desired number and/or shape of the inner chambers 85, 85a, 85b will be readily apparent to one skilled in the art. Additionally, the partitions 80 may be padded to protect shopping items and/or insulated to assist in maintaining the temperature of shopping items being transported therewith. Moreover, the primary bag 20 may also include other items such as ice packs, gels packs, padding, wine bag(s), etc.

The handled bags 30 are generally known in the art. Typically, the handled bags generally include a front face 90, rear face 95, a pair of side walls 100, and a base 105, which define a compartment 110 for receiving shopping items. However, the handled bags 30 may have any suitable construction as is known in the art, and every such construction is contemplated herein. The handled bags 30 may also include one or more handles 115 that may be affixed to the bag 30 or may be integral with the bag 30. The handled bags 30 may be constructed from any suitable material, including but not limited to a polymer, fabric, etc. Also, at least some of handled bags 30 may be insulated to assist in maintaining the temperature of shopping items being transported therewith. Furthermore, the handled bags 30 may be of the same size or may be different sizes.

In use, the handled bags 30 are retained within the inner chamber 55 of the primary bag 20. The user may then transport the shopping bag system 10 to a shopping location. The primary bag 20 may then be affixed to a shopping cart 75 through the use of the swivel clips 70. Once the user is finished shopping, the user may begin to remove the handled bags 30 from the primary bag 20 and use them to store shopping items therein. In addition, the user may also use the primary bag 20 to store shopping items therein. Once the user is finished with the bags 20, 30, the handled bags 30 may be returned to the primary bag 20.

Referring now to FIGS. 5-6, a second illustrative embodiment of a shopping bag system 200 is shown. The system 200 is similar to that of the first embodiment described above; thus, like numerals for like elements will be used throughout. The primary difference between the first illustrative embodiment and the second illustrative embodiment resides within side walls 205. In the second embodiment, the side walls 205 are corrugated thereby allowing the primary bag 20 to operate in an accordion-like fashion. Thus, the primary bag 20 may be moveable from a compact arrangement where the front face 35 is adjacent to the rear face 40 and an expanded arrangement where the front face 35 is spaced apart from the rear face 40. In addition, the primary bag may include a strap 210 coupled to the rear face 40. The strap 210 extends to, and is releaseably securable to, the front face 35 such that when the strap 210 is secured to the front face 35, the primary bag 20 is retained in the compact arrangement, and when the strap 210 is released from the front face 35, the primary bag 20 may be moved to the expanded arrangement. The strap 210 may be releaseably secured to the front face 35 by any suitable means, including but not limited to Velcro, magnets, buckle, hooks, etc.

In use, the handled bags 30 are retained within the inner chamber 55 of the primary bag 20. The user may then press the front face 35 towards the rear face 40 such that the primary bag 20 is in the compact arrangement. The strap 210 may be releaseably secured to the front face 35 so as to retain the primary bag 20 in the compact arrangement. The user may then transport the shopping bag system 200 to a shopping location. The primary bag 20 may then be affixed to a shopping cart 75 through the use of the swivel clips 70. Once the user is finished shopping, the user may release the strap 210 from the front face 35 of the primary bag 20 thereby allowing the primary bag 20 to move to the expanded arrangement. Next, the user may begin to remove the handled bags 30 from the primary bag 20 and use them to store shopping items therein. In addition, the user may also use the primary bag 20 to store shopping items therein. Once the user is finished with the bags 20, 30, the handled bags 30 may be returned to the primary bag 20.

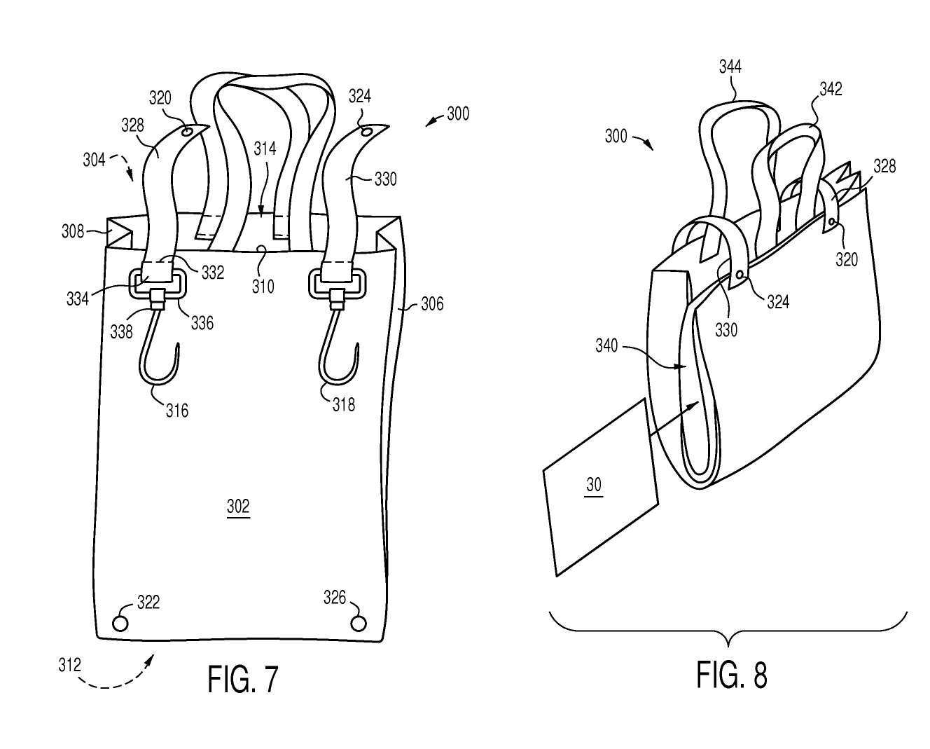

FIGS. 7 and 8 show a shopping bag 300 which may be folded to establish a U-configuration and releasably secured in the folded or U-configuration. The shopping bag 300 may comprise a front face 302, a rear face 304, a pair of opposing end walls 306, 308, an upper edge 310, and a bottom 312. The opposing end walls 306, 308 and the bottom 312 connect the front face 302 to the rear face 304, thereby defining a chamber 314 capable of receiving and retaining therein shopping items (not shown).

A first mounting fastener such as a first hook 316 may be coupled to one of the opposing end walls 306 or 308, the front face 302, or the rear face 304 (coupling to the front face 302 proximate the end wall 308 is depicted), the first hook 316 being capable of releasably securing the shopping bag 300 to a shopping cart such as the shopping cart 75 shown in FIG. 1. A second mounting fastener may be provided, such as a second hook 318 which, apart from being located proximate the opposed end wall 306, may be the structural and functional equivalent of the first hook 316.

A bag fastener may be coupled to one of the opposing end walls 306 or 308, the front face 302, or the rear face 304 proximate the upper edge 310. The bag fastener may be capable of releasably securing the shopping bag 300 in the folded condition shown in FIG. 8, wherein the upper edge 310 is releasably secured to the bottom 312 to establish the folded condition or U-configuration. The bag fastener may comprise at least one set of snaps, and optionally, two sets of snaps (as depicted). Each set of snaps comprises a first snap component such as a male snap component 320 fixed to the shopping bag 300 proximate the upper edge 310, and a second and complementing female snap component 322 fixed to the shopping bag 300 proximate the bottom 312. The set of snaps comprising the male snap component 320 and the complementing female snap component 322 may each be located proximate the end wall 308. A second set of snaps comprising a male snap component 324 and a complementing female snap component 326 may be located in corresponding locations on the shopping bag 300 but proximate the opposed end wall 306.

The male snap components 320, 324 may be disposed on respective short straps 328, 330 such that the male snap components 320, 324 may be positioned to overlie the female snap components 322, 326. The female snap components 322, 326 are visible in FIG. 7, but only that portion of each female snap component 322 or 326 which assists in sandwiching the constituent material of the shopping bag 300 for anchorage, rather than the female socket, is seen in FIG. 7. The female snap components 322, 326 are concealed from view in FIG. 8 by the overlying straps 328, 330.

Referring particularly to FIG. 7, the mounting fastener and the bag fastener may be anchored to the shopping bag 300 at a common anchorage point. This common anchorage point for the male snap component 320 and the hook 316 may comprise that point 332 at which the strap 328 is stitched to the front face 302 of the shopping bag 300. The strap 328 may be stitched in a manner forming a loop 334 which receives and retains a square ring 336 to which the hook 316 is mounted. The mounting arrangement of the hook 316 may comprise a swivel 338 disposed to enable orientation of the hook 316 to successfully engage constituent rods of a shopping cart such as the shopping cart 75.

The mounting arrangement of the strap 330 and the hook 318 may be structural and functional equivalents of those of the strap 328 and the hook 316, apart from location proximate the end wall 306.

In summary, one mounting fastener and one bag fastener are fixed to the shopping bag 300 at a first common anchorage point, while the second mounting fastener and the second bag fastener are fixed to the shopping bag 300 at a second common anchorage point.

Securement of the bag in the folded condition or U-configuration shown in FIG. 8 creates a space 340 into which articles such as the handled bags 30 shown in FIG. 2 may be inserted and carried about. Thus, the shopping bag 300 may be utilized both independently as a general purpose shopping bag and also as the primary bag of a shopping bag system such as that shown in FIG. 2 for example.

The shopping bag 300 may comprise at least one and if desired two handles 342, 344 which are fixed to the shopping bag 300 proximate the upper edge 310. The handles 342, 344 may be of construction similar to that of other handles and shoulder straps which are disclosed herein.

Where used herein, the term “at least” explicitly contemplates one, two, or more than two of the referenced item or items.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A bag system comprising:
a plurality of handled bags;
a primary bag comprising a front face, a rear face, a pair of opposing end walls and a bottom, wherein said opposing end walls and said bottom connect said front face to said rear face thereby defining a chamber capable of receiving said plurality of handled bags and wherein upon removing said handled bags from said chamber, said chamber is operable to retain shopping items therein; and
a fastener coupled to one of said opposing end walls, said front face, or said rear face, said fastener capable of releasably securing said primary bag to a shopping cart.

2. The bag system of claim 1 further comprising a partition, said partition capable of being releasably secured within said chamber to subdivide said chamber.

3. The bag system of claim 2 wherein said partition is insulated.

4. The bag system of claim 1 wherein said primary bag is insulated.

5. The bag system of claim 1 wherein said fastener is a swivel clip.

6. The bag system of claim 1 wherein said fastener is a magnet.

7. The bag system of claim 1 wherein said fastener is a Velcro strap.

8. A bag system comprising:
a plurality of handled bags;
a primary bag having an inner chamber, said chamber capable of retaining said plurality of handled bags therein, wherein upon removing said handled bags from said chamber, said chamber is operable to retain shopping items therein; and
a fastener coupled to said primary bag, said fastener capable of releasably securing said primary bag to a shopping cart.

9. The bag system of claim 8 wherein said primary bag is insulated.

10. The bag system of claim 8 further comprising a partition, said partition capable of being releasably secured within said chamber to subdivide said chamber.

11. The bag system of claim 10 wherein said partition is insulated.

12. The bag system of claim 8 wherein said fastener is a swivel clip.

13. A shopping bag comprising
a front face, a rear face, a pair of opposing end walls, an upper edge, and a bottom, wherein said opposing end walls and said bottom connect said front face to said rear face thereby defining a chamber capable of receiving and retaining therein shopping items;
a mounting fastener coupled to one of said opposing end walls, said front face, or said rear face, said mounting fastener capable of releasably securing said primary bag to a shopping cart; and
a bag fastener coupled to one of said opposing end walls, said front face, or said rear face proximate said upper edge, said bag fastener capable of releasably securing said shopping bag in a folded condition wherein said upper edge is releasably secured to said bottom to establish a U-configuration.

14. The shopping bag of claim 13, wherein said bag fastener comprises at least one set of snaps further comprising a first snap component fixed proximate said upper edge and a second complementing snap component fixed proximate said bottom.

15. The shopping bag of claim 14, wherein said at least one set of snaps comprises a first set of snaps wherein one said first snap component of said first set of snaps is located proximate one said end wall and a second set of snaps wherein one said first snap component of said second set of snaps is located proximate the other said end wall.

16. The shopping bag of claim 13, further comprising at least one handle fixed to said shopping bag proximate said upper edge.

17. The shopping bag of claim 13, wherein said mounting fastener comprises a hook.

18. The shopping bag of claim 13, wherein said mounting fastener and said bag fastener are anchored to said shopping bag at a common anchorage point.

19. The shopping bag of claim 13, wherein said mounting fastener comprises a first hook located proximate one said end wall and a second hook located proximate the other said end wall.

20. The shopping bag of claim 13, wherein said mounting fastener comprises a first hook located proximate one said end wall and a second hook located proximate the other said end wall and said bag fastener comprises a first set of snaps wherein one said first snap component of said first set of snaps is located proximate one said end wall and a second set of snaps wherein one said first snap component of said second set of snaps is located proximate the other said end wall, and wherein said first hook and said first set of snaps are anchored to said shopping bag at a first common anchorage point, and said second hook and said second set of snaps are anchored to said shopping bag at a second common anchorage point.
